(19) United States
(12) Patent Application Publication
(10) Pub. No.: US 2011/0070279 A1
(43) Pub. Date: Mar. 24, 2011

(54) Anti-bug fabric

(75) Inventor: Ju-Sung Chang, Nantou County (TW)

(73) Assignee: Jone-Shou Industrial Co., Ltd

(21) Appl. No.: 12/585,757

(22) Filed: Sep. 24, 2009

(51) Int. Cl. A01N 25/34

(52) U.S. Cl. 424/411

(57) ABSTRACT

An anti-bug fabric is a flat piece of fabric and composed of multiple longitudinal strings and multiple altitude strings which are weaved to the longitudinal strings. Each of the longitudinal strings and altitude strings includes an inner portion and an outer portion which wraps to the inner portion, wherein the inner portion is composed of multiple wires and the outer portion is made plastic material mixed with anti-bug material.

### BACKGROUND OF THE INVENTION

(1) Field of the Invention

The present invention relates to a fabric, and more particularly, to a fabric composed of strings weaved to each other and each string includes an outer portion which includes anti-bug material.

(2) Description of the Prior Art

Bugs and mosquitoes are a serious concern for the people in outdoor activities, especially for some areas where have high humidity and temperature. Most people use mosquito spray to protect themselves. However, most of the sprays are made y chemical material which is harmful to the users, although some sprays are made by natural material.

The shortcomings for the use of the conventional sprays are that the spray cannot last long on the users' skin because of sweats or water during activities. When the humidity is high, the density of the spray becomes low and cannot function as desired. The users have to spray often and this has to be done by stopping the activities.

The present invention intends to provide an anti-bug fabric which is composed longitudinal and altitude strings, each string includes an outer portion mixed with anti-bug material.

### SUMMARY OF THE INVENTION

The present invention relates to an anti-bug fabric which comprises multiple longitudinal strings and multiple altitude strings. Each of the longitudinal strings and altitude strings includes an inner portion and an outer portion which wraps to the inner portion. The inner portion is composed of multiple wires and the outer portion is made plastic material mixed with anti-bug material.

The primary object of the present invention is to provide an anti-bug fabric which can be made to be scarves, table sheets, tents or clothes. The anti-bug material in the outer portions of the present invention keeps bugs and mosquitoes away from the users.

Another object of the present invention is to provide an anti-bug fabric wherein the anti-bug material is not in a form of liquid so that the humidity and temperature do not affect the density thereof so as to have satisfied results.

Yet another object of the present invention is to provide an anti-bug fabric which can be made to be scarves used on people or even animals.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the anti-bug fabric of the present invention;

FIG. 2 is an enlarged view to show the inner portion and outer portion of the strings of the anti-bug fabric of the present invention;

FIG. 3 is a cross sectional view to show the inner portion and outer portion of the strings of the anti-bug fabric of the present invention;

FIG. 4 shows that the melted outer portion is mixed with the anti-bug material;

FIG. 5 shows that the multiple longitudinal strings and multiple altitude strings are weaved to each other;

FIG. 6 shows that the anti-bug fabric of the present invention is used as a table sheet;

FIG. 7 shows that the anti-bug fabric of the present invention is used as a vest, and

FIG. 8 shows that the anti-bug fabric of the present invention is put on the back of a horse.

### DETAILED DESCRIPTION OF THE PREFERRED EMBODIMENT

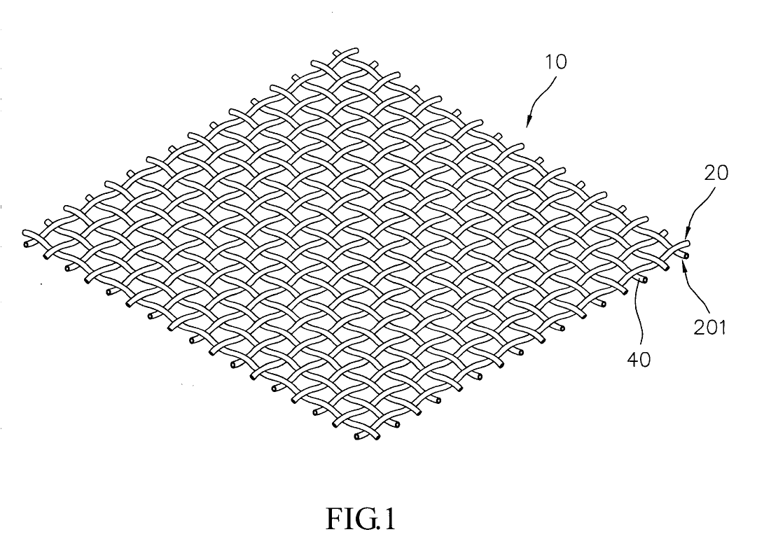

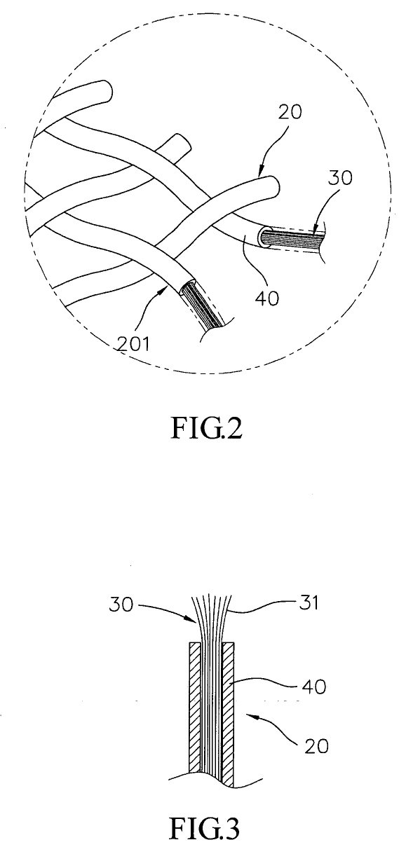

Referring to FIGS. 1 to 3, the anti-bug fabric of the present invention comprises multiple longitudinal strings 201 and multiple altitude strings 20 which are weaved to the longitudinal strings 201 as shown in FIG. 5 so as to form as a flat piece of fabric 10. Each of the longitudinal strings 201 and altitude strings 20 includes an inner portion 30 and an outer portion 40 which wraps to the inner portion 30. The inner portion 30 is composed of multiple wires 31 which can be nylon or cotton wires. The outer portion 40 is made plastic material mixed with anti-bug material. The outer portion 40 can be made of Polyethylene, Polyvinyl chloride or Thermoplastic rubber. The material for the outer portion 40 have low melting point and protects the inner portion 30 and provides the longitudinal strings 201 and altitude strings 20 with proper flexibility.

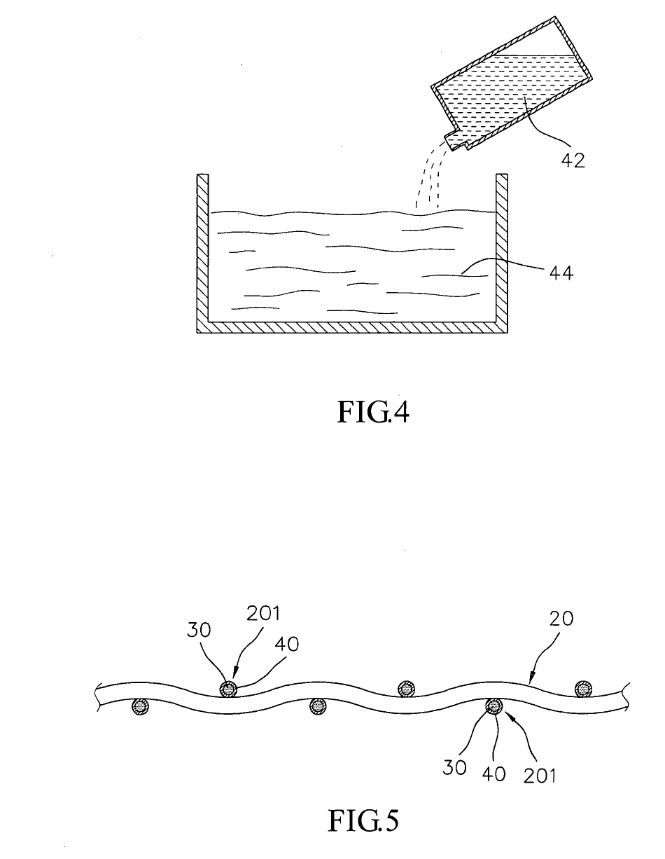

Referring to FIG. 4, the outer portion 40 is mixed with anti-bug material 44 when the outer portion 40 is in a fluid status 42. It is noted that the low melting temperature for the outer portion 40 does not change the features of the anti-bug material 44 which is plant oil from Citronella, Melaleuca, or Eucalyptus. The mixture is then extruded or injected to wrap to the inner portion 30. The multiple longitudinal strings 201 and multiple altitude strings 20 are weaved to be a flat piece of fabric 10, wherein the longitudinal strings 201 and the multiple altitude strings 20 may have different colors.

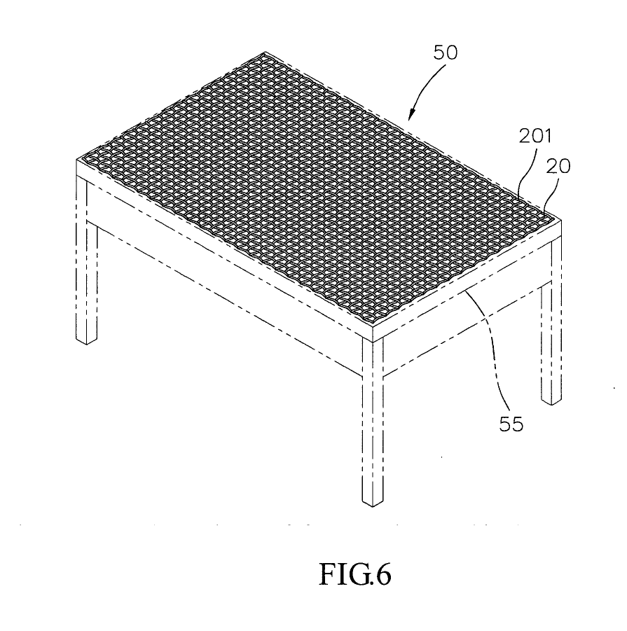

FIG. 6 shows that the anti-bug fabric of the present invention is used as a table sheet 50 which is put on the top of the table 55. The anti-bug material 44 spreads from the table sheet 50 so that the bugs or mosquitoes are away from the people close to the table 50 in backyard activities. The anti-bug material 44 can last for months.

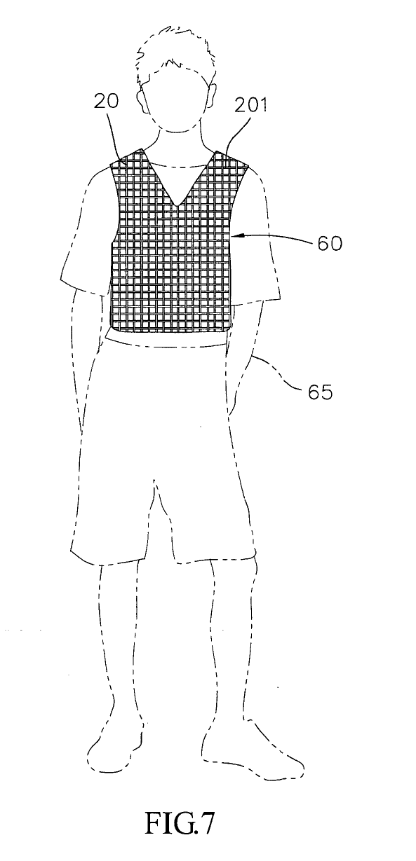

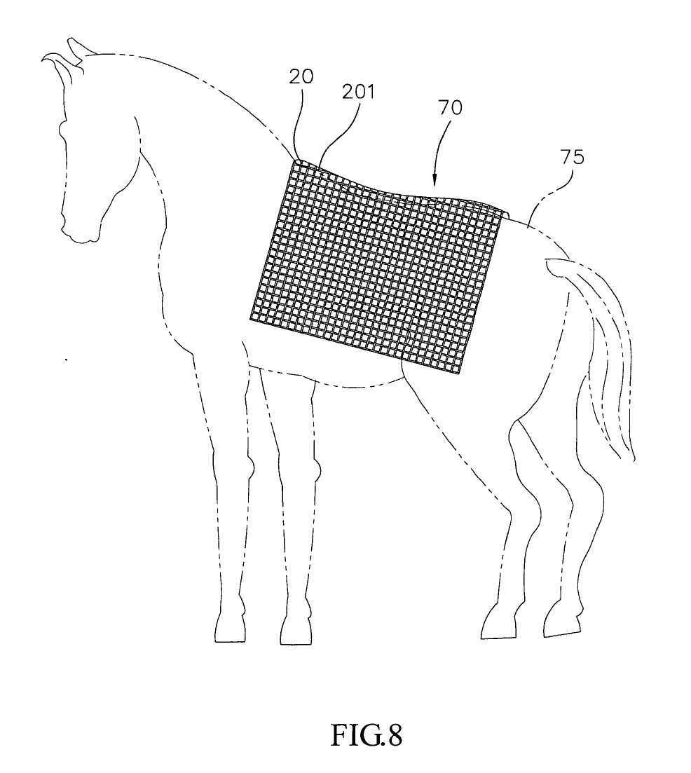

FIG. 7 shows that the anti-bug fabric of the present invention is used as a vest 60 and the wearer 65 does not bothered by the bugs or mosquitoes. FIG. 8 shows that the anti-bug fabric of the present invention is used as a blanket 70 put on the back of a horse 75 and the anti-bug material 44 from the blanket 70 keeps the bugs or mosquitoes away from the horse 75. The smell of the Citronella can clam down the horse 75.

While we have shown and described the embodiment in accordance with the present invention, it should be clear to those skilled in the art that further embodiments may be made without departing from the scope of the present invention.

What is claimed is:

1. An anti-bug fabric comprising:
multiple longitudinal strings and multiple altitude strings, each of the longitudinal strings and altitude strings including an inner portion and an outer portion which wraps to the inner portion, the inner portion composed of multiple wires and the outer portion being made plastic material mixed with anti-bug material.

2. The anti-but fabric as claimed in claim 1, wherein the outer portion is made of Polyethylene, Polyvinyl chloride or Thermoplastic rubber.

3. The anti-bug fabric as claimed in claim 1, wherein the outer portion is mixed with anti-bug material when the outer portion is in a fluid status, the anti-bug material is plant oil from Citronella, Melaleuca, or Eucalyptus.

4. The anti-bug fabric as claimed in claim 1, wherein the multiple longitudinal strings and multiple altitude strings are weaved to be a flat piece of fabric.
